(19) United States
(12) Patent Application Publication
(10) Pub. No.: US 2022/0130058 A1
(43) Pub. Date: Apr. 28, 2022

(54) MISSION EARLY LAUNCH TRACKER

(71) Applicant: Raytheon Company, Waltham, MA (US)

(72) Inventors: Chia Y. Chang, San Marcos, CA (US); Caprice A. Wilbur, San Diego, CA (US); Robert K. Pina, Ramona, CA (US); Julian S. Brody, Southampton, NY (US)

(21) Appl. No.: 17/081,247

(22) Filed: Oct. 27, 2020

(51) Int. Cl. G06T 7/292; G01S 11/12; G06K 9/32

(52) U.S. Cl. CPC G06T 7/292; G01S 11/12; G06T 2207/30212; G06T 2207/30241; G06K 2009/3291; G06K 9/32

(57) ABSTRACT

A tracking system for a target flight vehicle includes at least two sensor nodes that are positioned at geographically diverse locations relative to a launch site from which the target flight vehicle is launched. The sensor nodes have a lens and a visible camera that captures images of an anticipated launch trajectory for the target flight vehicle. The sensor nodes determine position data for the target flight vehicle including timing, azimuth, and elevation based on the captured images. A fusion processing engine is communicatively coupled to the at least two sensor nodes for receiving and integrating the position data. The data is integrated to determine real-time state vectors including a velocity and a three-dimensional position for the target flight vehicle. The state vectors are sent to a range network that is configured to implement a flight termination system for the target flight vehicle based on the state vectors.

### GOVERNMENT LICENSE RIGHTS

This disclosure was made with Government support under contract number N68936-16-D-0007, awarded by the Department of Defense. The Government has certain rights in the disclosure.

### FIELD OF DISCLOSURE

The disclosure relates to a tracking system for a missile during missile flight testing.

### DESCRIPTION OF THE RELATED ART

Prior to normal operation of a missile, the missile is subject to flight testing at a missile range facility. During flight testing, the missile may be unexpectedly subject to failure, such as by a mechanical failure of fins. Accordingly, missile testing systems are configured to mitigate or prevent hazards associated with the missile testing, including mitigating the high energetic missile debris which may negatively impact the environment and life on the ground. Situational awareness of the missile flight performance is used to determine when a mitigation action is to be taken in the event that early flight termination of the missile is required on the missile safety range. Determining whether to initiate a mitigation action requires acquisition of critical range safety data by Range Safety Officers immediately after launching the test missile, such as within one or two seconds.

Missile flight testing systems typically include GPS telemetry, radars, and electro-optical components that detect and track the missile to provide range data for the missile. Using the multiple components provides redundancy to ensure accurate detection and tracking of the missile. In one prior attempt to provide an electro-optical component of the system, operators use sensors, which are also referred to as observers, and plexiglass camera screens that are overlaid with nominal trajectories for a particular test missile of interest. The operators verbally relay the initial fly-out assessment for the missile to the Range Safety Officer.

However, the prior attempt to provide an electro-optical system may be deficient in that the fly-out assessment is subjective and is not optimal for fast missiles. Accordingly, there may be a delay before critical information is relayed to the Range Safety Officer. Consequently, the Range Safety Officer cannot initiate the flight termination system within the short time frame required for mitigation. GPS telemetry and radars are also deficient as to the timing in which they are able to provide information to the Range Safety Officer in that these systems may also be delayed in being able to detect and track the target missile. Thus, the critical range safety data in the first several seconds of a launch may not be accurately detected by any of the current systems.

### SUMMARY OF THE DISCLOSURE

The present application aims to provide an automated electro-optical system and computer-implemented method for integration in a range safety system for a missile. The system and method is configured to provide a fused track of a missile during fly-out in addition to real-time displays of the launch. In a general embodiment, a tracking system for a target flight vehicle includes at least two sensor nodes that are positioned at geographically diverse locations relative to a launch site from which the target flight vehicle is launched. The sensor nodes have a lens and at least one visible camera configured to capture images of an anticipated launch trajectory for the target flight vehicle. The sensor nodes are configured to determine position data for the target flight vehicle including timing, azimuth, and elevation based on the captured images. A fusion processing engine is communicatively coupled to at least two sensor nodes for receiving and integrating the position data from the at least two sensor nodes. The data is integrated to determine real-time state vectors including a velocity and a three-dimensional position for the target flight vehicle. The state vectors are sent to a range network that is configured to implement a flight termination system for the target flight vehicle based on the state vectors.

The tracking system and method is advantageous in that the system can be integrated into existing range safety systems to provide situational awareness to the Range Safety Officer. The system is automated such that the critical range safety data may be acquired, processed, and made available to the Range Safety Officer within one to two seconds after missile launch, as compared with GPS telemetry which starts detection after approximately ten seconds from launch and radars which start detection after approximately three or more seconds from launch. The Range Safety Officer uses the state vector solution of the target flight vehicle to calculate instantaneous impact position that may be used to assess whether a flight termination system is to be initiated when the target flight vehicle has off-nominal flight.

The sensor nodes use static, visible cameras and wide view lenses. Prior to launch, alignment of the system is performed using in-scene fiducial reference points and algorithms pertaining to the projection between image space and object space, such that real-time look angles are computed by each sensor node. The sensor nodes are configured to correct lens distortion based on standard lens corrections and are also configured to characterize the lens distortion using target boards. Focal length measurement of the sensor nodes is performed using star clusters. The sensor nodes and the fusion processing engine are also regulated to a common clock using GPS time servers.

The sensor nodes include detection logic that is configured to use a region-of-interest to detect the initial launch, filter out false tracks that are not the target flight vehicle, predict a projected path for the target flight vehicle to ensure tracking of the target flight vehicle during coast phases that occur between burning stages of a multi-stage missile, mitigating clutter in the field-of-view of the camera, and perform pixel centroiding to determine the target location from a cluster of detected pixels. Using the detection logic, the sensor node generates time-stamped real-time target angular positions that are fed to the fusion processing engine. The fusion processing engine is configured to asynchronously combine the angular position data into a fused track to produce the state vectors, using geometric triangulation or Kalman filtering.

According to an aspect of the disclosure, a tracking system for a missile is configured to determine a fused track of a missile during fly-out and provide real-time displays of the launch.

According to an aspect of the disclosure, a tracking system for a missile includes at least two sensor nodes arranged at geographically diverse positions relative to a launch site, wherein cameras of the two sensor nodes are arranged at cross-angles.

According to an aspect of the disclosure, a tracking system for a missile includes a fusion processing engine that is configured to fuse position data from at least two sensor nodes to generate a state vector including three-dimensional position and velocity of the missile.

According to an aspect of the disclosure, a tracking system for a missile is configured to provide a real-time state vector including three-dimensional position and velocity of the missile to a range safety system.

According to an aspect of the disclosure, a tracking system for a missile is configured to provide critical range safety data for the missile within one to two seconds after the missile launch.

According to an aspect of the disclosure, a tracking system for a target flight vehicle includes at least two sensor nodes that are positioned at geographically diverse locations relative to a launch site from which the target flight vehicle is launched, each of the at least two sensor nodes having a lens and at least one visible camera configured to capture images of an anticipated launch trajectory for the target flight vehicle, each of the at least two sensor nodes being configured to determine position data for the target flight vehicle based on the captured images, and a fusion processing engine communicatively coupled to the at least two sensor nodes. The fusion processing engine is configured to receive the position data for the target flight vehicle from the at least two sensor nodes, integrate the position data from the at least two sensor nodes to determine real-time state vectors for the target flight vehicle, and send the real-time state vectors to a range network that is configured to implement a flight termination system for the target flight vehicle based on the real-time state vectors.

According to an embodiment in accordance with any paragraph(s) of this summary, the position data may be determined by the at least two sensor nodes includes elevation and azimuth for the target flight vehicle, and the real-time state vectors may be determined by the fusion processing engine includes a three-dimensional position and velocity for the target flight vehicle.

According to an embodiment in accordance with any paragraph(s) of this summary, the fusion processing engine may be configured to integrate the data by performing a geometric triangulation or Kalman filtering.

According to an embodiment in accordance with any paragraph(s) of this summary, each of the at least two sensor nodes may include a global positioning system time server whereby the at least two sensor nodes and the fusion processing engine are regulated to a common clock. The fusion processing engine is synchronized to a different regulated time source from the sensor nodes.

According to an embodiment in accordance with any paragraph(s) of this summary, each of the at least two sensor nodes may be configured to determine the position data for the target flight vehicle based on alignment of the at least two sensor nodes relative to fiducial reference points located in field of views of the at least two sensor nodes.

According to an embodiment in accordance with any paragraph(s) of this summary, each of the at least two sensor nodes may be configured to rotate a focal plane of the camera for alignment with a horizon.

According to an embodiment in accordance with any paragraph(s) of this summary, at least one of the fusion processing engines and the at least two sensor nodes may be configured to filter out a false track that does not correspond to the target flight vehicle.

According to an embodiment in accordance with any paragraph(s) of this summary, each of the at least two sensor nodes may include detection logic that is configured to detect an initial launch of the target flight vehicle from the launch site based on a region-of-interest of a corresponding one of the at least two sensor nodes.

According to an embodiment in accordance with any paragraph(s) of this summary, the tracking system may include a memory containing stored data corresponding to the anticipated launch trajectory, wherein the detection logic is configured to determine a projected trajectory for the target flight vehicle based on the anticipated launch trajectory.

According to an embodiment in accordance with any paragraph(s) of this summary, the detection logic may be configured to mitigate clutter in a field of view of a corresponding one of the at least two sensor nodes.

According to an embodiment in accordance with any paragraph(s) of this summary, the detection logic may be configured to determine a location of the target flight vehicle using pixel centroiding.

According to an embodiment in accordance with any paragraph(s) of this summary, the at least two sensor nodes may be arranged at cross-angles relative to each other.

According to an embodiment in accordance with any paragraph(s) of this summary, the at least one visible camera may include two visible cameras for redundancy.

According to an embodiment in accordance with any paragraph(s) of this summary, the lens of at least one of the at least two sensor nodes may be a wide view lens and the one of the at least two sensor nodes is configured to correct lens distortion and characterize lens distortion by measuring a focal length of the lens relative to star cluster reference points.

According to another aspect of the disclosure, a computer implemented method for tracking a target flight vehicle includes capturing images of an anticipated launch trajectory for the target flight vehicle by sensor nodes arranged in at least two geographically diverse locations relative to a launch site from which the target flight vehicle is launched, determining position data for the target flight vehicle including timing, azimuth, and elevation based on the captured images, sending the position data for the target flight vehicle from the sensor nodes to a fusion processing engine, integrating the position data from the sensor nodes to determine real-time state vectors including a velocity and a position for the target flight vehicle, and sending the real-time state vectors to a range safety system that is configured to implement a flight termination system for the target flight vehicle based on the real-time state vectors.

According to an embodiment in accordance with any paragraph(s) of this summary, integrating the position data may include one of performing a geometric triangulation or performing Kalman filtering.

According to an embodiment in accordance with any paragraph(s) of this summary, the method may include aligning the sensor nodes based on fiducial reference points located in field of views of the sensor nodes and a horizon.

According to an embodiment in accordance with any paragraph(s) of this summary, the method may include regulating the sensor nodes and the fusion processing engine to a common clock.

According to an embodiment in accordance with any paragraph(s) of this summary, the method may include characterizing and correcting lens distortion in wide view lenses of the sensor nodes based on star cluster reference points.

According to an embodiment in accordance with any paragraph(s) of this summary, the method may include filtering out false tracks that do not correspond to the target flight vehicle, and mitigating clutter in field of views of the sensor nodes.

To the accomplishment of the foregoing and related ends, the disclosure comprises the features hereinafter fully described and particularly pointed out in the claims. The following description and the annexed drawings set forth in detail certain illustrative embodiments of the disclosure. These embodiments are indicative, however, of but a few of the various ways in which the principles of the disclosure may be employed. Other objects, advantages and novel features of the disclosure will become apparent from the following detailed description of the disclosure when considered in conjunction with the drawings.

### BRIEF DESCRIPTION OF DRAWINGS

The annexed drawings, which are not necessarily to scale, show various aspects of the disclosure.

FIG. 1 shows a tracking system for detecting and tracking a target flight vehicle on a safety range.

FIG. 2 shows the tracking system of FIG. 1 including sensor nodes that are arranged at geographically diverse locations relative to a launch site for the target flight vehicle.

FIG. 3 shows pre-determined safety corridor lines for the target flight vehicle for comparison with the imagery captured by the tracking system of FIG. 1.

FIG. 4 shows a computer-implemented method for tracking a target flight vehicle using the tracking system of FIG. 1.

FIG. 5 shows an exemplary field-of-view for the sensor nodes in which the sensor nodes are aligned using reference fiducials in the field-of-view.

### DETAILED DESCRIPTION

The principles described herein have application in tracking systems for flight vehicles, such as missiles. The system and method described herein may be used on a safety range and integrated into an existing range safety system for communication and integration with other components and systems of the range safety system. For example, the range safety system may include any suitable radar system and global positioning system (GPS) telemetry for a target flight vehicle. The radar system, the GPS telemetry, and the tracking system described herein may all be used to detect and track the target flight vehicle to provide critical range safety data to a Range Safety Officer.

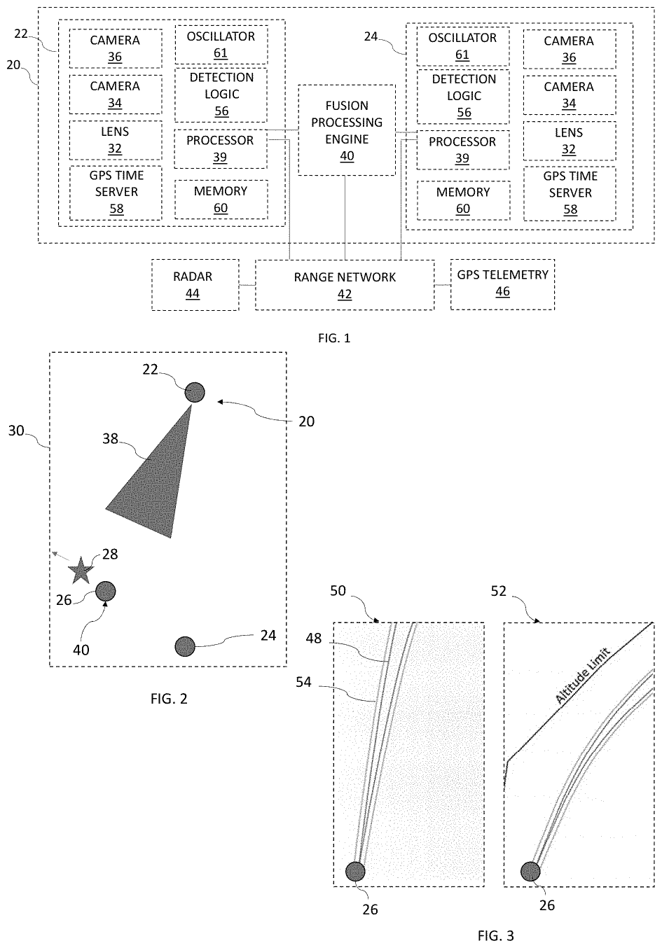

Referring first to FIGS. 1 and 2, a tracking system 20 for tracking a target flight vehicle, such as a missile, during flight testing on a safety range is shown. As shown in FIG. 2, the tracking system 20 includes at least two sensor nodes 22, 24 that are positioned at geographically diverse locations relative to a launch site 26 from which at least one target flight vehicle 28 is launched. The sensor nodes 22, 24 are arranged at cross-angles relative to each other to provide “scissor-angle” viewing of the launch site 26. In an exemplary embodiment, the sensor nodes 22, 24 may be arranged behind the launch site 26 such that the target flight vehicle 28 moves in a direction away from the sensor nodes 22, 24 during flight.

The launch site 26 is located on a safety range 30 that is configured for flight testing of the target flight vehicle. The safety range 30 includes a range network that is configured to detect and track the target flight vehicle 28, and provide critical range safety data pertaining to the target flight vehicle 28 to a Range Safety Officer. Detection and tracking of the target flight vehicle 28 may be performed redundantly by multiple systems communicatively coupled to the range network. More than two sensor nodes 22, 24 may be provided in the tracking system 20 and the sensor nodes 22, 24 are configured to detect and track the target flight vehicle 28. For example, the tracking system 20 may be configured to detect and track the target flight vehicle 28 within the first ten seconds of launch. More than one target flight vehicle 28 may be launched and the sensor nodes 22, 24 may be configured to detect and track more than one target flight vehicle.

Each of the sensor nodes 22, 24 includes a lens 32 and at least one visible camera 34, 36 that has a field-of-view 38, as shown in FIG. 2. In exemplary embodiments, at least two cameras 34, 36 may be provided at the same geographic location to provide multiple field-of-views that enlarge a field-of-regard for the sensor nodes 22, 24. The camera 34, 36 of the corresponding sensor node 22, 24 is configured to stare at an anticipated launch trajectory for the target flight vehicle 28 and capture images of the target flight vehicle 28. The anticipated launch trajectory may be determined based on previous trajectories of flight vehicles similar to the target flight vehicle 28. The corresponding sensor node 22, 24 includes a processor 39 that is configured to receive the images from the camera 34, 36 and determine pointing data, or position data for the target flight vehicle 28 based on the images taken in the field-of-view 38 for the corresponding sensor node 22, 24. The sensor node 22, 24 uses algorithms to process the two-dimensional images and generate position data including timing, azimuth, and elevation of the target flight vehicle 28.

The position data determined by the sensor nodes 22, 24 is sent to a fusion processing engine 40 of the tracking system 20. The fusion processing engine 40 is communicatively coupled to each of the sensor nodes 22, 24. The sensor nodes 22, 24 and the fusion processing engine 40 may include any software, firmware, and/or hardware implementation, including microprocessors and circuitry such as a field programmable gate array (FPGA). The fusion processing engine 40 is arranged at a third geographically diverse location relative to the sensor nodes 22, 24. For example, the fusion processing engine 40 may be arranged at the launch site 26, as shown in FIG. 2.

The fusion processing engine 40 is configured to receive the position data from each of the sensor nodes 22, 24 and asynchronously combine or integrate the position data to determine real-time state vectors including a velocity and a three-dimensional position for the target flight vehicle 28. The sensor nodes 22, 24 are configured to transmit the position data to the fusion processing engine 40 using an established range network protocol. In exemplary embodiments, two or more fusion processing engines may be provided for redundancy. The fusion processing engine 40 is then configured to send the real-time state vectors to a range network 42 using a specific message format, such that the real-time state vectors are used as an input for other systems in the range network 42. The range network 42 may also include a radar system 44 and GPS telemetry 46 that also provide range safety data over the range network 42.

The tracking system 20 is advantageous in providing situational awareness for the target flight vehicle 28. The Range Safety Officer can receive essentially instantaneous real-time data pertaining to the position of the target flight vehicle 28 over the range network 42. For example, the tracking system 20 may be configured to determine the real-time state vectors of approximately the first ten seconds of the fly out for the target flight vehicle 28. Advantageously, the tracking system 20 is also configured to acquire, process, and send the critical range safety data to the Range Safety Officer within one or two seconds after missile launch, such that the tracking system 20 may be used as an automated system in place of conventional “skyscreen” methods.

Accordingly, the Range Safety Officer is able to calculate Instantaneous Impact Positions (IIPs) to determine whether to initiate a flight termination system for the target flight vehicle 28 based on the real-time state vector. The range network 42 is configured to use the radar system 44, GPS telemetry 46, and the tracking system 20 as a redundant system to ensure accurate detection for the target flight vehicle 28. For example, the GPS telemetry 46 may be able to detect and track the target flight vehicle 28 after ten seconds from the initial launch and the radar system 44 may be able to detect and track the target flight vehicle 28 after at least three seconds from the initial launch. The detection timing for the systems may be dependent on the application.

With further reference to FIG. 3, in addition to the fused state vector solution provided by the tracking system 20 via the fusion processing engine 40, situational awareness for the target flight vehicle 28 is also provided by the sensor nodes 22, 24 being configured to send live video to the range network 42 from each of the sensor nodes 22, 24. The range network 42 is configured to receive the real-time video. As shown in FIG. 3, pre-determined safety corridor lines 48 for the target flight vehicle 28 are overlaid on the imagery from the video for comparison. Corridor line displays 50, 52 including the safety corridor lines 48 may correspond to each of the sensor nodes 22, 24. The safety corridor lines 48 are used to predict a trajectory of the target flight vehicle 28. Boundary lines 54 are also pre-determined using typically a three-sigma limit and used to accommodate for measurement uncertainties. By comparing the safety corridor lines 48 with the captured imagery from the sensor nodes 22, 24, the Range Safety Officer can determine if the target flight vehicle 28 is outside of the safety corridor lines 48 and thus outside of range safety limits, such that the flight termination system may be initiated.

Referring back to FIG. 1, each of the sensor nodes 22, 24 further includes detection logic 56, a GPS time server 58, and a memory 60. The detection logic 56 is used in enabling the sensor node 22, 24 to determine the position data for the target flight vehicle 28. The detection logic 56 is configured to detect an initial launch of the target flight vehicle 28 from the launch site 26 based on a region-of-interest of the camera 34, 36 a corresponding one of the sensor nodes 22, 24. For example, the detection logic 56 may be configured to detect the initial flight flash. The sensor nodes 22, 24 may thus be configured to automatically start detection and recording in response to the determination of the initial launch. Furthermore, the sensor nodes 22, 24 may be configured to automatically stop detection and recording. For example, detection by the sensor nodes 22, 24 may stop after a predetermined amount of time of flight for the target flight vehicle 28, or if flight termination for the target flight vehicle 28 is initiated.

During detection of the target flight vehicle 28, the detection logic 56 is also configured to detect and filter out false tracks, such as birds or other objects that are in the field-of-view 38 of the sensor node 22, 24 and are not the target flight vehicle 28. The detection logic 56 may be able to validate a detected object as being the target flight vehicle 28 using angular separation of the detection and comparing the separation with the anticipated launch trajectory. For example, the target flight vehicle 28 is only able to move within a certain pixel range for the corresponding camera 36 and the range may be used by the processor 39 of the sensor node 22, 24 to determine whether a detection is erroneous. Alternatively, or in addition to the sensor nodes 22, 24, the fusion processing engine 40 may also be configured to filter out false tracks based on the anticipated launch trajectory.

The detection logic 56 is also configured to provide track prediction. The memory 60 of the sensor node 22, 24 may be configured to store data pertaining to track history for flight vehicles that are similar to the target flight vehicle 28. For example, the track history may be stored as a look-up table. The detection logic 56 can use the track history to predict the projected path for the target flight vehicle 28 to ensure that the sensor nodes 22, 24 are able to capture images of the target flight vehicle 28. For example, if the missile is a multi-stage missile having multiple thrusting stages, the target flight vehicle 28 burning during the first stage is tracked by the sensor nodes 22, 24. After the first stage burn is completed, the brightness of the target flight vehicle 28 may decrease between the stage burns, i.e. during the “coast” phase. Accordingly, without track prediction, the target flight vehicle 28 would not be able to be tracked until the second stage ignition and the brightness of the target flight vehicle 28 is increased. Using the projected path for the target flight vehicle 28 determined by the detection logic 56, the target flight vehicle 28 is able to be detected by the sensor nodes 22, 24 during the coast phase or multiple coast phases. Thus, coverage of the target flight vehicle 28 is ensured.

The detection logic 56 is further able to mitigate clutter in the field-of-view for the sensor nodes 22, 24. For example, the detection logic 56 may be configured to use background subtraction to reduce the in-scene clutter when capturing images. Still another function of the detection logic 56 is pixel centroiding which enables the sensor node 22, 24 to determine the precise location of the target flight vehicle 28 from a cluster of detected pixels.

Each captured image is timestamped by a PC oscillator 61 of the corresponding sensor node 22, 24 to provide timing of the captured image. The tracking system 20 is configured to operate based on a regulated common time via the GPS time servers 58 used at each sensor node 22, 24 and the fusion processing engine 40. The GPS time servers are used to provide accurate timing between the tracking system 20 and the range network 42 by regulating the tracking system 20 to a common clock. The tracking system 20 is configured to performing timing characterizations to determine timestamp latencies within microsecond accuracy.

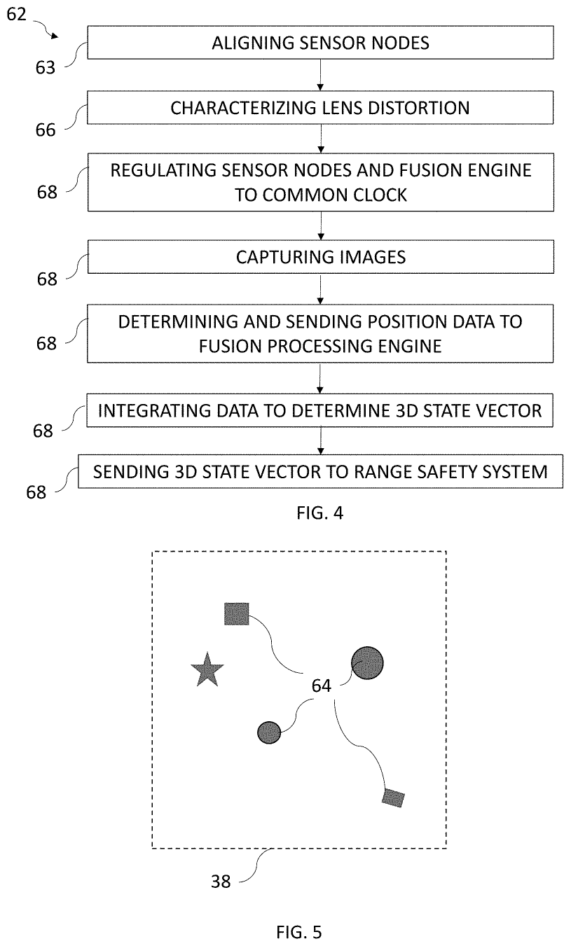

Referring now to FIG. 4, a computer-implemented method 62 for tracking the target flight vehicle 28 is shown. The computer-implemented method 62 is carried out by the tracking system 20 shown in FIG. 1. Prior to detection and tracking, the method 62 includes alignment and calibration of the tracking system 20. Step 63 of the method 62 includes calibrating and aligning the cameras 34, 36 of the sensor nodes 22, 24 arranged at geographically diverse locations (shown in FIGS. 1 and 2). The cameras 34, 36 may be any suitable static, visible cameras. A single lens 32 may be used and multiple cameras 34, 36 may be used at each geographic location for redundancy. The cameras 34, 36 are configured to maintain coverage of the target flight vehicle 28 by providing multiple field-of-views. Using multiple cameras with multiple fields-of-view from a single observer location enlarges a field-of-regard for the sensor nodes 22, 24, such that a large spatial region for the target flight vehicle 28 may be placed under constant observation to generate a desired angular resolution within the boundaries of the focal plane.

Referring in addition to FIG. 5, the calibration and alignment may be automated, or may be performed manually depending on the application. The cameras 34, 36 may be mounted to gimbals such that the gimbals may be moved to initially position the cameras 34, 36. The alignment of the sensor nodes 22, 24 includes using in-scene reference points, or fiducials 64 that are in the field-of-view 38 of the camera 34, 36 for the corresponding sensor node 22, 24. Fiducials 64 may include antennas, buildings, or any other reference point located in the field-of-view 38. The fiducials 64 are spaced apart and the longitude, latitude, and altitude is known for each fiducial 64.

The data pertaining to the fiducials 64 may be stored in the memory 60 of the sensor node 22, 24, such as in a look-up table. The three-dimensional positions for the fiducials 64 are projected into two-dimensional pixel space, such that the pixel footprint represents the real-world scenario. The sensor nodes 22, 24 are configured to compute real-time look angles including an azimuth and elevation for the target flight vehicle 28 using an algorithm pertaining to the projection of the pixel image space into object space.

The gimbals to which the cameras 34, 36 are mounted may be moved, such as by robotics for aligning the cameras 34, 36. For example, operators may be able to remotely operate the sensor nodes 22, 24. The cameras 34, 36 are arranged at cross-angles relative to each other. The camera 34, 36 is then pointed in a desired direction and the field-of-view 38 is aligned using the pixel space and the known data pertaining to the fiducials 64. Alignment of the camera 34, 36 is further performed based on the horizon which is known. For example, the focal plane of the camera 34, 36 may be rotated for alignment based on the horizon.

Step 66 of the method 62 includes correcting lens distortion and characterizing the lens distortion of the lenses 32. Each camera 34, 36 may include a single lens and the lens may be dependent on the application, such as to meet a particular mission requirement. At least one of the lenses 32 of the cameras 34, 36 may be a wide angle lens, such that the wide angle lens introduces distortion into the field-of-view 38 of the camera 34, 36. Both of the lenses 32 may be wide view lenses or one of the lenses 32 may have a narrower field-of-view. Using the wide angle lens is advantageous in that the sensor node 22, 24 has a large viewing area, such that the target flight vehicle 28 cannot accelerate outside of a viewing area for the sensor nodes 22, 24. The sensor nodes 22, 24 are configured to incorporate known lens distortion correction for the lens being used using a predetermined curvature or distortion definition.

The sensor nodes 22, 24 are configured to characterize the lens distortion and measure the lens distortion characterization. For a lens having a narrower field-of-view, a smaller target board having a symmetrical pattern may be used to characterize the distortion and for calibration of the lens. For a wide angle lens having an infinite focus, smaller target boards are unable to be used for calibration. Accordingly, characterizing the distortion for a wide angle lens 32 may be performed by collecting light in the sensor node 22, 24 and pointing the camera 34, 36 upwardly to the sky, using known star clusters as fiducials. Accordingly, the focal length of the lens 32 can be measured at infinity focus against a star cluster.

During calibration and alignment of the tracking system 20, step 68 of the method 62 includes regulating the sensor nodes 22, 24 and the fusion processing engine 40 to a regulated clock such that timestamp latencies are assessed to microsecond accuracy. GPS time servers 58 are used at each node 22, 24 and the fusion processing engine 40 to provide accurate timing for the range network 42 (shown in FIG. 1). The GPS time is automatically steered to coordinated universal time (UTC) and the timing is used to regulate the PC oscillator 61 for each sensor node 22, 24. The PC oscillator 61 is configured to timestamp the position data received at each sensor node 22, 24 based on the regulated time when the determined position data is sent to the fusion processing engine 40.

After calibration and alignment, the tracking system 20 is set up, and the tracking system 20 is ready for detection and tracking of the target flight vehicle 28 during launch. The target flight vehicle 28 is launched from the launch site 26 (shown in FIG. 2) and step 70 of the method 62 includes capturing images of the anticipated launch trajectory for the target flight vehicle 28 by the sensor nodes 22, 24. The sensor nodes 22, 24 are configured to stare at the anticipated launch trajectory, collect imagery, and process the imagery that is used to measure the focal plane location of the target flight vehicle 28. Step 70 may include using at least one of using a region-of-interest to detect the initial launch. For example, the sensor nodes 22, 24 may be automatically initiated for detection and tracking of the target flight vehicle 28 in response to detection of an initial launch flash or light.

Step 70 of the method 62 may further include using detection logic 56 of the sensor nodes 22, 24 (shown in FIG. 1) to filter out false tracks in the field-of-view that are not the target flight vehicle 28. Step 70 may also include using the detection logic 56 to predict a projected path for the target flight vehicle 28 to ensure tracking of the target flight vehicle 28 during coast phases in a multi-stage missile. Additionally, the detection logic 56 may be used to mitigate clutter in the field-of-view and pixel centroiding to determine a precise location of the target flight vehicle 28 from a cluster of pixels. Using the detection logic 56 is advantageous in ensuring quality of the imagery for determining the position data.

Step 72 of the method 62 includes determining the pointing information, i.e. the position data for the target flight vehicle 28 based on the captured images and sending the position data from the sensor nodes 22, 24 to the fusion processing engine 40. The position data includes timing, azimuth, and elevation, which are determined based on the alignment of the tracking system 20 to the fiducials 64 and algorithms that pertain to the projection of the pixel space into object space. The processor 39 of each sensor node 22, 24 is able to compute real-time look angles including the azimuth and elevation for different positions of the target flight vehicle 28 during flight of the target flight vehicle 28.

The PC oscillator 61 timestamps the position data for the target flight vehicle 28 and the position data is then sent to the fusion processing engine 40 from each of the sensor nodes 22, 24. Step 74 of the method 62 includes asynchronously combining the position data or integrating the position data into a fused track that produces real-time state vectors including a three-dimensional position and velocity for the target flight vehicle 28. Step 74 may include performing a geometric triangulation among the sensor nodes 22, 24 and the fusion processing engine 40 or performing Kalman filtering to integrate the position data from the sensor nodes 22, 24.

Step 76 of the method 62 includes sending the real-time state vectors to the range network 42 using a specific message format such that the state vectors are used by different systems in the range safety system as an input. The Range Safety Officer may then use the state vectors to determine whether to implement a flight termination system for the target flight vehicle 28 if the target flight vehicle 28 is determined to have off-nominal flight.

Advantageously, the state vectors may be automatically provided to the Range Safety Officer within two seconds of the initial launch and within 200 milliseconds of detection, such that the tracking system and method described herein is advantageous over conventional plexiglass camera screen methods that are performed manually. In exemplary embodiments, the tracking system may be configured to provide the state vector at a minimum rate of ten solutions per second. The target flight vehicle may be detected and tracked for at least the first ten seconds of the launch, and used in conjunction with other systems of the range network, such as a radar system. The tracking system is advantageous in providing situational awareness to the Range Safety Officer with a fused state vector solution and a live video stream of the missile launch.

Various techniques described herein may take the form of program code (i.e., instructions) embodied in tangible media, such as floppy diskettes, compact disc-read-only memory (CD-ROMs), digital versatile disc (DVD), hard drives, non-transitory computer readable storage medium, or any other machine-readable storage medium. When the program code is loaded into and executed by a machine, such as a computer, the machine becomes an apparatus for practicing the various techniques. Circuitry may include hardware, firmware, program code, executable code, computer instructions, and/or software. A non-transitory computer readable storage medium may be a computer readable storage medium that does not include signal. In the case of program code execution on programmable computers, the computing device may include a processor, a storage medium readable by the processor (including volatile and non-volatile memory and/or storage elements), at least one input device, and at least one output device.

The volatile and non-volatile memory and/or storage elements may be a random-access memory (RAM), erasable programmable read only memory (EPROM), flash drive, optical drive, magnetic hard drive, solid state drive, or other medium for storing electronic data. One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

The functional unit described in this specification may be a module or more than one module which may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like. The module may also be implemented in software for execution by various types of processors. An identified module of executable code may, for instance, comprise one or more physical or logical blocks of computer instructions, which may, for instance, be organized as an object, procedure, or function. The executables of an identified module need not be physically located together, but may comprise disparate instructions stored in different locations which, when joined logically together, comprise the module and achieve the stated purpose for the module.

A module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

Although the disclosure includes certain preferred embodiment or embodiments, it is obvious that equivalent alterations and modifications will occur to others skilled in the art upon the reading and understanding of this specification and the annexed drawings. In particular regard to the various functions performed by the above described elements (external components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the disclosure. In addition, while a particular feature of the disclosure may have been described above with respect to only one or more of several illustrated embodiments, such feature may be combined with one or more other features of the other embodiments, as may be desired and advantageous for any given or particular application.

1. A tracking system for a target flight vehicle, the tracking system comprising:
at least two sensor nodes that are positioned at geographically diverse locations relative to a launch site from which the target flight vehicle is launched, each of the at least two sensor nodes having a lens and at least one visible camera configured to capture images of an anticipated launch trajectory for the target flight vehicle, each of the at least two sensor nodes being configured to determine position data for the target flight vehicle based on the captured images; and
a fusion processing engine communicatively coupled to the at least two sensor nodes, wherein the fusion processing engine is configured to:
receive the position data for the target flight vehicle from the at least two sensor nodes;
integrate the position data from the at least two sensor nodes to determine real-time state vectors for the target flight vehicle; and
send the real-time state vectors to a range network that is configured to implement a thrust termination system for the target flight vehicle based on the real-time state vectors.

2. The tracking system according to claim 1, wherein the position data determined by the at least two sensor nodes includes elevation and azimuth for the target flight vehicle, and wherein the real-time state vectors determined by the fusion processing engine includes a three-dimensional position and velocity for the target flight vehicle.

3. The tracking system according to claim 1, wherein the fusion processing engine is configured to integrate the data by performing a geometric triangulation or Kalman filtering.

4. The tracking system according to claim 1, wherein each of the at least two sensor nodes includes a global positioning system time server whereby the at least two sensor nodes and the fusion processing engine are regulated to a common clock.

5. The tracking system according to claim 1, wherein each of the at least two sensor nodes is configured to determine the position data for the target flight vehicle based on alignment of the at least two sensor nodes relative to fiducial reference points located in field of views of the at least two sensor nodes.

6. The tracking system according to claim 1, wherein each of the at least two sensor nodes is configured to rotate a focal plane of the camera for alignment with a horizon.

7. The tracking system according to claim 1, wherein at least one of the fusion processing engine and the at least two sensor nodes are configured to filter out a false track that does not correspond to the target flight vehicle.

8. The tracking system according to claim 1, wherein each of the at least two sensor nodes includes detection logic that is configured to detect an initial launch of the target flight vehicle from the launch site based on a region-of-interest of a corresponding one of the at least two sensor nodes.

9. The tracking system according to claim 8 further comprising a memory containing stored data corresponding to the anticipated launch trajectory, wherein the detection logic is configured to determine a projected trajectory for the target flight vehicle based on the anticipated launch trajectory.

10. The tracking system according to claim 8, wherein the detection logic is configured to mitigate clutter in a field of view of a corresponding one of the at least two sensor nodes.

11. The tracking system according to claim 8, wherein the detection logic is configured to determine a location of the target flight vehicle using pixel centroiding.

12. The tracking system according to claim 1, wherein the at least two sensor nodes are arranged at cross-angles relative to each other.

13. The tracking system according to claim 1, wherein the at least one visible camera includes two visible cameras for redundancy.

14. The tracking system according to claim 13, wherein the lens of at least one of the at least two sensor nodes is a wide view lens and the one of the at least two sensor nodes is configured to correct lens distortion and characterize lens distortion by measuring a focal length of the lens relative to star cluster reference points.

15. A computer implemented method for tracking a target flight vehicle, the computer implemented method comprising:
capturing images of an anticipated launch trajectory for the target flight vehicle by sensor nodes arranged at least two geographically diverse locations relative to a launch site from which the target flight vehicle is launched;
determining position data for the target flight vehicle including timing, azimuth, and elevation based on the captured images;
sending the position data for the target flight vehicle from the sensor nodes to a fusion processing engine;
integrating the position data from the sensor nodes to determine real-time state vectors including a velocity and a position for the target flight vehicle; and
sending the real-time state vectors to a range safety system that is configured to implement a thrust termination system for the target flight vehicle based on the real-time state vectors.

16. The computer-implemented method according to claim 15, wherein integrating the position data includes one of performing a geometric triangulation or performing Kalman filtering.

17. The computer-implemented method according to claim 15 further comprising aligning the sensor nodes based on fiducial reference points located in field of views of the sensor nodes and a horizon.

18. The computer-implemented method according to claim 15 further comprising regulating the sensor nodes and the fusion processing engine to a common clock.

19. The computer-implemented method according to claim 15 further comprising characterizing and correcting lens distortion in wide view lenses of the sensor nodes based on star cluster reference points.

20. The computer-implemented method according to claim 15 further comprising:
filtering out false tracks that do not correspond to the target flight vehicle; and
mitigating clutter in field of views of the sensor nodes.
